(19) United States
(12) Patent Application Publication
(10) Pub. No.: US 2008/0093206 A1
(43) Pub. Date: Apr. 24, 2008

(54) Key cap structure

(75) Inventors: Chao-Lung Chang, Miaoli County (TW); Ling-Hsi Chao, Taoyuan County (TW)

Correspondence Address: BIRCH STEWART KOLASCH & BIRCH, PO BOX 747, FALLS CHURCH, VA, 22040-0747, US

(73) Assignee: Darfon Electronics Corp.

(21) Appl. No.: 11/907,919

(22) Filed: Oct. 18, 2007

(30) Foreign Application Priority Data
Oct. 20, 2006 (TW) 095218525

(51) Int. Cl. H01H 13/14

(52) U.S. Cl. 200/341

(57) ABSTRACT

A key cap structure is disclosed, which comprises: a key cap, a connection structure, and a reinforcement element, wherein, the reinforcement element is arranged beneath the bottom of the key cap by the connection structure. Preferably, the key cap and the reinforcement element are separately formed so that the manufacturing of such key cap structure can be simplified while avoiding the disposition of the connection structure from causing the shrinking of key cap's surface during formation, and also as the reinforcement elements can be made of various alignments, thickness, height, materials according to the specification of the key cap structure or actual requirements, the key cap structure can be sufficiently strengthened.

### FIELD OF THE INVENTION

The present invention relates to a key cap structure, and more particularly, to a key cap structure having separately formed key cap and reinforcement element, in that as the key cap and the reinforcement element are formed separately so that the manufacturing of such key cap structure can be simplified, and also as the reinforcement elements can be made of various alignments, thickness, height, materials according to the specification of the key cap structure or actual requirements, the key cap structure can be sufficiently, strengthened for adapting the same for computers, cellular phones, personal digital assistants (PDAs) or the like.

### BACKGROUND OF THE INVENTION

Keyboards, being the input devices widely used in various electronic apparatuses, such as computers, cellular phones and PDAs, can be composed of a plurality of keys with various sizes and shapes. In addition, for ensuring each key to be pressed smoothly and thus function correctly no matter where a force is exerted on the key cap, each key is usually designed with an reinforcement rib or balance bar under its key cap to balance the depressing force. Force distribution is especially important for keys of longer width, such as the “space” key, which typically require additional structure to balance the force exerted on the end of its key cap. Currently, it is common to form such reinforcement structure and the key cap integrally. However, the key cap with integrally formed reinforcement structure has the following shortcomings:
(1) Following the trend of lighter, thinner and smaller design, it is preferred to have thinner key cap. However, when a key cap is integrally formed with a poorly designed reinforcement structure or with a thick reinforcement structure, such key cap consequently is going to surfer for having a shrinking pressing surface that no only it is not good looking, but also the yield is poor.
(2) As such reinforcement structure is disposed beneath the key cap, its disposition is restricted by those other structures formed under the key cap in a manner that it is unable to evenly distribute the pressing force over the entire surface of the key cap.

Please refer to FIG. 1, which shows a scissors-shaped key disclosed in U.S. Pat. No. 6,726,093, entitled “Keyboard and key structure with scissors-shaped frame”. In FIG. 1, the scissors-shaped key includes a key cap 1a, a scissors-shaped frame 2a, a balance bar 3a, and a base 4a. The balance bar 3a includes a first end 31a and a second end 32a. The first end 31a is pivotally coupled to a pivoting support 11a disposed on the bottom of the key cap 1a. The second end 32a passes through a corresponding ditch 43a disposed on the base 4a. Although, by the aforesaid structure, the surface shrinkage problem suffering those conventional keys with reinforcement ribs integrally formed with key caps, such scissors-shaped key still has the following shortcomings:
(1) The scissors-shaped frame 2a might not be adapted for all kinds of pressing keys.
(2) As the balance bar 3a is disposed crossing with the scissors-shaped frame 2a, it is difficult to assemble.
(3) For accommodating the pivoting supports 11a and the ditches 43a, the key cap 1a and the base 4a must be designed with sufficient areas and the height from the bottom of the key cap 1a to the base 4a must be increased so that the weight and volume of such scissors-shaped key is increased.
(4) As the structure of such scissors-shaped key is comparatively complex, the manufacturing cost is relatively high.

Please refer to FIG. 2, which shows a key structure disclosed in TW Appl. No. 93216053, entitled “keyboard”. In FIG. 2, a connecting element 14 is extending from the bottom of a key cap 1, and a balance bar 16 is integrally formed at an end of the connecting element 14, in which a pair of latches 26 are rotatably coupled to the two ends of the balance bar 16. The aforesaid structure is designed to evenly distribute a force exerted on the key cap while also enabling the key to be manufactured with lower cost. However, comparing with the key structure shown in FIG. 1, the disposition of the connecting element 14 and the balance bar 16 is just an transformation of the first end 31a and the second end 32a of the balance bar 3a shown in FIG. 1 while the latch 26 is functioning equivalent to the ditch 43a and the connecting element 14 to the second end 32a. The difference between the two is that: the connecting element 14 is integrally formed with the key cap 1. However, just because the connecting element 14 is integrally formed with the key cap 1, not only it will cause the structure of the key cap 1 to be complicated, but also the conventional the surface shrinkage problem remain unsolved. Moreover, Since those complicated components including the connecting element 14, the balance bar 16 and the latches 26 must be arranged within the limited available space under the key cap 1, it is doubled that such key structure can not achieve satisfactory strength.

### SUMMARY OF THE INVENTION

In view of the disadvantages of prior art, the primary object of the present invention is to provide a key cap structure, configured with a reinforcement element beneath the bottom of a key cap by the coupling of a connection structure. As the key cap and the reinforcement element are separately formed, the manufacturing of such key cap structure can be simplified while avoiding the disposition of the connection structure from causing the shrinking of key cap's surface during formation, and also as the reinforcement elements can be made of various alignments, thickness, height, materials according to the specification of the key cap structure or actual requirements, the key cap structure can be sufficiently strengthened.

To achieve the above object, the present invention provides a key cap structure, comprising: a key cap configured with a bottom; a connection structure; and a reinforcement element, coupled to the bottom of the key cap by the connection structure.

Preferably, the reinforcement element is a flat plate.

Preferably, the reinforcement element further comprises at least a rib formed thereon.

Preferably, the at least one rib is formed by a manner selected from the group consisting of: integrally forming the at least one rib on the reinforcement element, and separately forming the at least one rib on the reinforcement element.

Preferably, there are more than one rib formed on the reinforcement element, and the ribs, each being a flexible bar, are disposed in a manner selected from the group consisting of: the ribs are aligned parallel to each other, the ribs are aligned perpendicular to each other, the rib are aligned intercrossing with each other, and the combination thereof.

Preferably, the connection structure is composed of mating holes and protrusions.

Preferably, the holes are formed on the reinforcement element while the protrusions are formed on the bottom of the key cap at positions corresponding to the holes.

Preferably, the protrusions are mated tightly with the holes.

Preferably, the protrusions wedged inside the holes are fixed therein by a means selected from the group consisting of: thermal bonding and gluing.

Preferably, the connection structure is composed of a clasp and a groove.

Preferably, the clasp is formed on the bottom of the key cap while the groove is formed on the reinforcement element while at a position corresponding to the clasp.

Preferably, the connection structure is a clamping device capable of fixedly holding the reinforcement element by exerting a clamping force thereon.

Preferably, the reinforcement element and the connection structure are made of a material selected from the group consisting of metals, platics, composite materials and the combination thereof.

Preferably, the connection structure is formed by a manner selected from the group consisting of: integrally forming connection structure with the key cap, and separately f forming connection structure with the key cap.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 shows a scissors-shaped key disclosed in U.S. Pat. No. 6,726,093.

FIG. 2 shows a key structure disclosed in TW Pat. No.

FIG. 3 is an explosive view of a key cap structure according to a first embodiment of the invention.

FIG. 4 is a three-dimensional view of the key cap structure of the first embodiment of the invention.

FIG. 4A is an enlarged diagram depicting the A portion of FIG. 4.

FIG. 5 is a three-dimensional view of a key cap structure of a second embodiment of the invention.

FIG. 6 is a three-dimensional view of a key cap structure of a third embodiment of the invention.

FIG. 6A is an enlarged diagram depicting the B portion of FIG. 6.

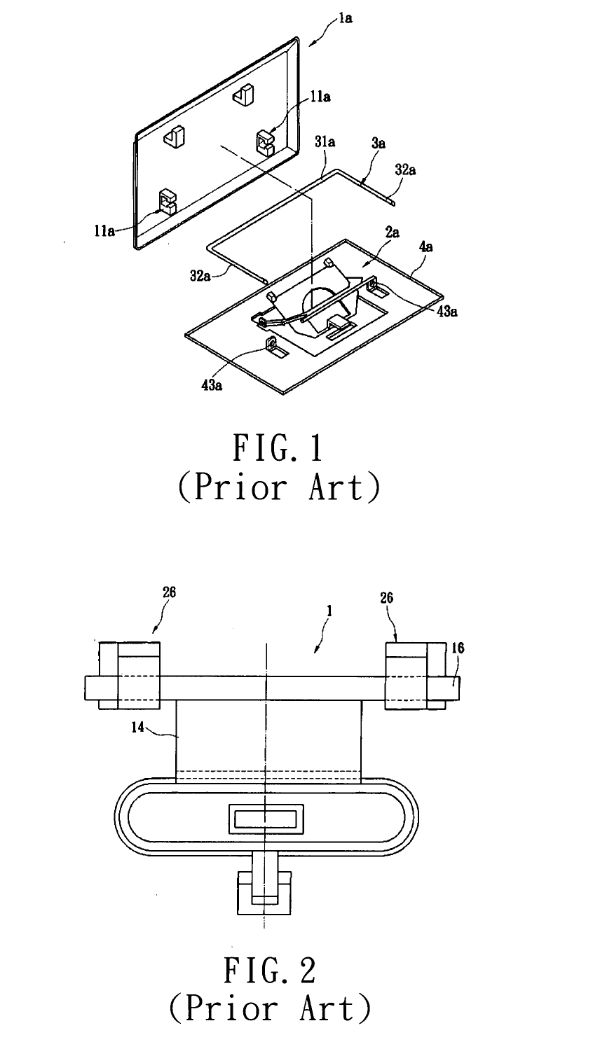

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

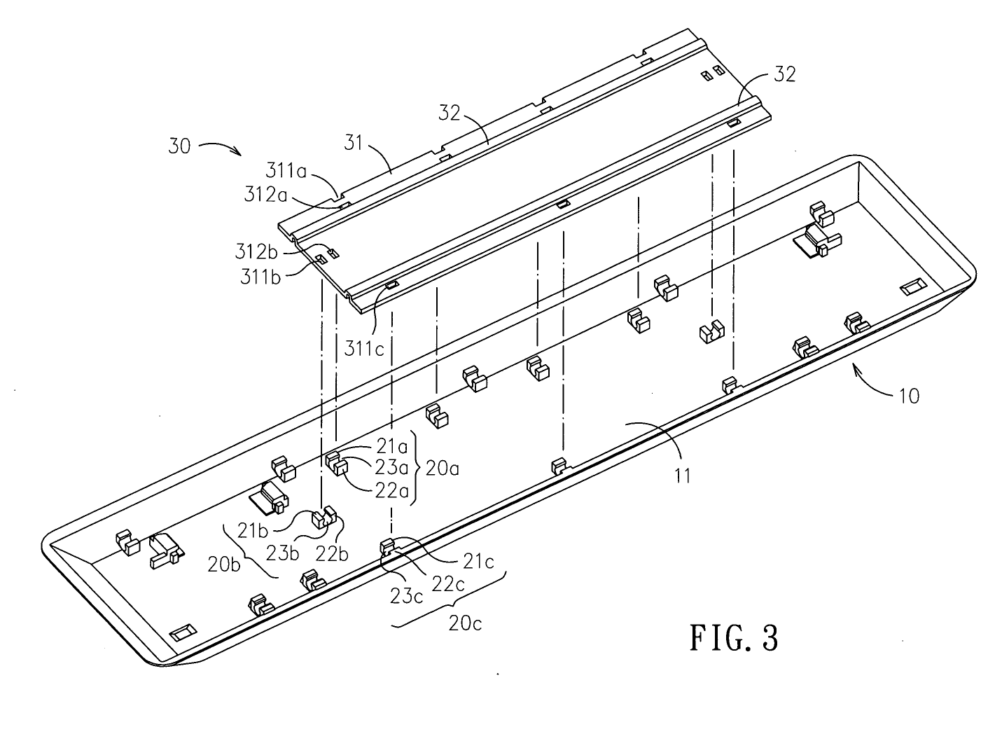

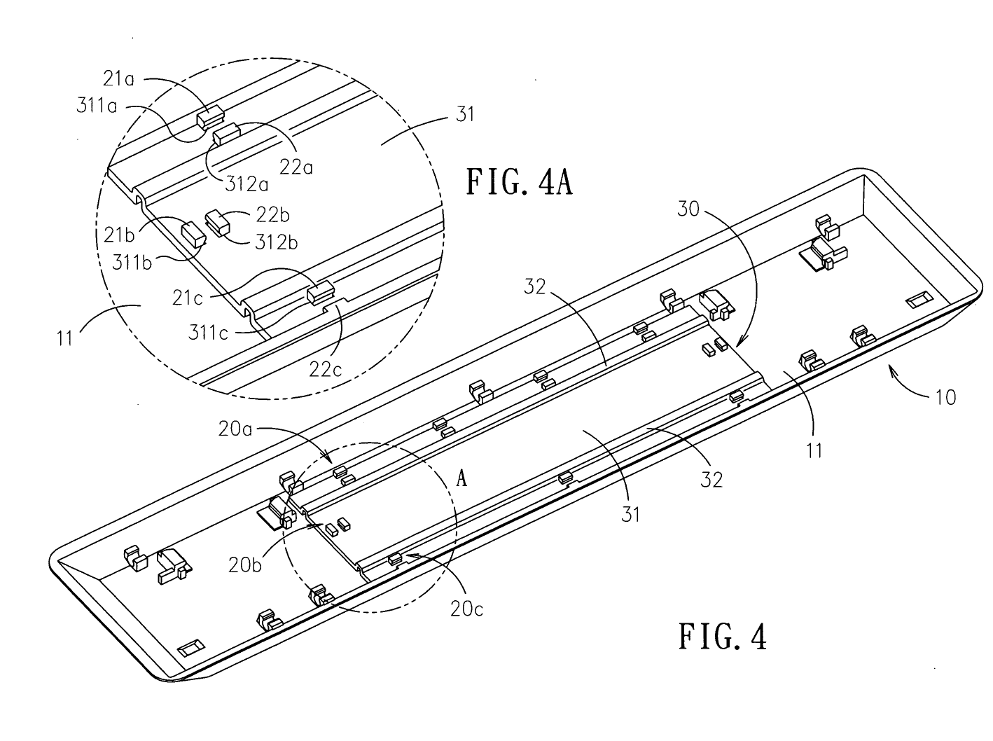

As shown in FIG. 3, FIG. 4 and FIG. 4A, the key cap structure of the invention includes a key cap 10 configured with a recessed bottom 11. It is noted that the key cap shown in this first embodiment is a bar-like “space” key while is disposed bottom up for illustration. There are a plurality of connection structures formed on the bottom 11, e.g. the connection structures 20a, 20b and 20c. The connection structure 20a is composed of two protruding parts 21a and 22a, that the two protruding parts 21a, 22a are symmetrically disposed on the bottom while allowing a groove-like space 23a to be formed therebetween. Similarly, the connection structure 20b is composed of two protruding parts 21b and 22b, that the two protruding parts 21b, 22b are symmetrically disposed on the bottom while allowing a groove-like space 23b to be formed therebetween. The difference between the two connection structures 20a and 20b is that: the two protruding parts 21a, 22a is arranged for aligning the axial line centering its groove-like space 23a to perpendicular to that of the groove-like space 23b sandwiched between the two protruding parts 21b, 22b of the connection structure 20b. In addition, the connection structure 20c is also composed of two protruding parts 21c and 22c, that the two protruding parts 21a, 22a are symmetrically disposed on the bottom while allowing a groove-like space 23a to be formed therebetween. However, the difference between the two connection structures 20a and 20c is that: the protruding part 22c is disposed extending from a sidewall 12 of the key cap 10. It is noted that the key cap 10 as well as the connection structures 20a, 20b and 20c can be made of a material selected from the group consisting of metals, platics, composite materials and the combination thereof.

The disposition of those connection structures 20a, 20b and 20c are designed to work cooperatively with the reinforcement element 30. The reinforcement element 30 is substantially a flat plate 31 having a plurality of ribs 32 formed thereon, in which each rib 32 can be integrally formed or separately formed on the flat plate 31. It is noted that the shape of the flay plate 31 are dependent upon the shape of the key cap 10 as well as the available surface and space beneath the bottom 11 of the key cap 10, which is not necessary to be a rectangle plate as the one shown in FIG. 3. As for the alignment of the ribs 32, it is dependent upon the shapes of the plate 31 and the key cap 10. In FIG. 3, the ribs 32 are two bars disposed parallel to each other along the longitudinal sides of the plate 31. However, they can be disposed perpendicular to or intercrossing with each other. Moreover, there are a plurality of holes 311a, 312a, 311b, being formed on the plate 31 at positions corresponding to the connection structures 20a, 20b, 20c in a manner that the protruding parts 21a, 22a, 21b, 22b, 21c and can be wedged into the holes 311a, 312a, 311b, 312b, and 311c respectively and correspondingly so as to tightly connected the reinforcement element 30 to the bottom 11 of the key cap 10. In this embodiment, the hole 311a is substantially a notch formed at the edge of the plate 31; and there is no hole formed for corresponding with the protruding part 22c. It is noted that the holes are formed on the plate 31 for mating with the corresponding protruding parts on the bottom 11 of the key cap 10. Accordingly, the clamp-type connection structures composed of holes and protruding parts can be replaced by clasps, by that the reinforcement element 30 can be connected to the bottom 11 of the key cap 10 by coupling the clasps with corresponding holes. In addition, other then forming holes on the plate 31 and protruding parts on the bottom 11 of the key cap 10, the hole can be formed on the bottom 11 while forming the protruding parts on the plate 31 which also can be used for connecting the reinforcement element 30 to the bottom 11 of the key cap 10.

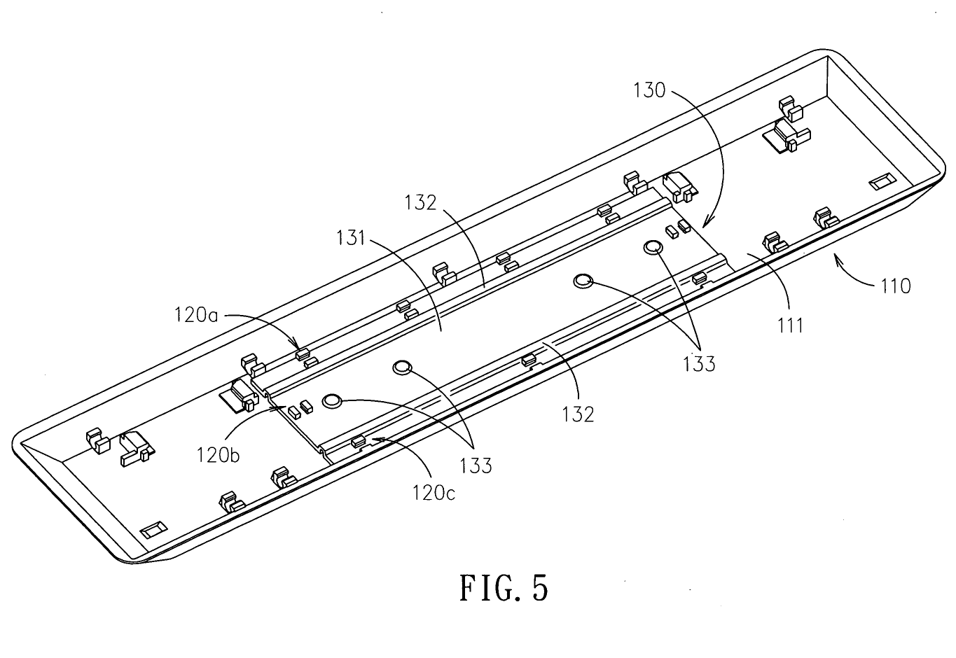

Please refer to FIG. 5, which is a three-dimensional view of a key cap structure of a second embodiment of the invention. Similar to the key cap structure shown in the first embodiment, the key cap structure of FIG. 5 comprises a key cap 110 configured with a recessed bottom 111. There are a plurality of connection structures formed on the bottom 111, e.g. the connection structures 120a, 120b and 120c that the connection structures are used for connecting a reinforcement element 130 to the bottom 111 of the key cap 110. Moreover, there are two parallel-disposed ribs 132 formed on the reinforcement element 130. It is noted that all the abovementioned components have functions the same as those described in the first embodiment, and thus are not described further herein. Nevertheless, the characteristic of the second embodiment is that: the plate 131 of the reinforcement element 130 is further being adhered onto the key cap 110 by thermal bonding means 133. The thermal bonding can be applied by a variety of methods. One of which is to dispose plastic protruding parts on the bottom 111 of the key cap at positions corresponding to the holes 133 formed on the plate 131, and then, by melting the plastic protruding part wedged inside the holes, the reinforcement element 130 can adhered onto the key cap 110 after the melted plastic protruding parts are solidified. It is noted that thermal bonding can be used independently, or it can be used cooperatively with the connection structures 120a, 120b and 120c as needed.

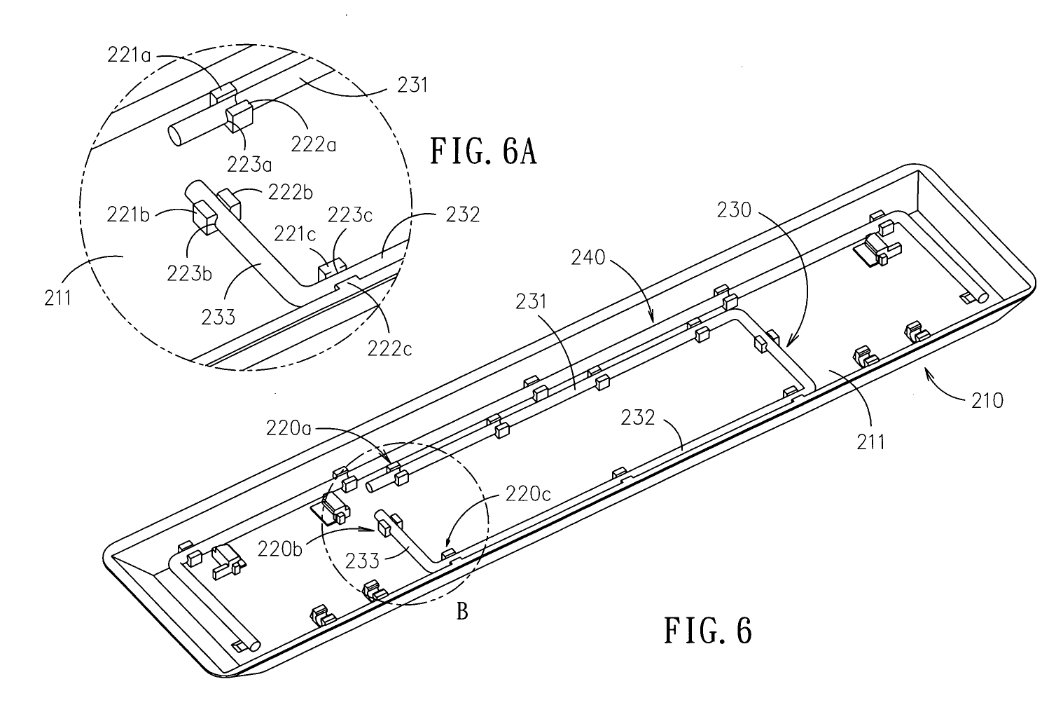

Please refer to FIG. 6 and FIG. 6A, which is a three-dimensional view of a key cap structure of a third embodiment of the invention. Similar to the key cap structure shown in the first embodiment, the key cap structure of FIG. 6 comprises a key cap 210 configured with a recessed bottom 211. There are a plurality of connection structures formed on the bottom 111, e.g. the connection structures 220a, 220b, and 220c that the connection structures are used for connecting a reinforcement element 230 to the bottom 211 of the key cap 210. It is noted that all the abovementioned components have functions the same as those described in the first embodiment, and thus are not described further herein. Nevertheless, the characteristic of the second embodiment is that: the reinforcement element 231 is a flexible bar composed of a first section 231, a second section 232 and a third section 233. As the disposition of two protruding parts 221a and 222a of each connection structure 220a allows a groove-like space 223a to be formed therebetween and that is also true for each connection structure 220b, 220c for forming groove-like spaces 223b, 223c, the first, the second and the third sections 231, 232, 233 of the reinforcement element 230 can be respectively inset into such spaces 223a, 223b and 223c so that the reinforcement element 230 can be hold securely by the connection structures 220a, 220b, and 220c, and thus the reinforcement element 230 is connected to the bottom 211 of the key cap 210. In addition, except for the aforesaid reinforcement element 231, other reinforcement element can be arranged in the key cap structure as required, such as the [symbol] -shaped reinforcement element 240 shown in FIG. 6. Therefore, the shape of the reinforcement element 230, 240 can be varied as required, and it can be made of a material selected from the group consisting of metals, platics, composite materials and the combination thereof.

To sum up, the present invention provides a key cap structure, configured with a reinforcement element beneath the bottom of a key cap by the coupling of a connection structure. As the key cap and the reinforcement element are separately formed, the manufacturing of such key cap structure can be simplified while avoiding the disposition of the connection structure from causing the shrinking of key cap's surface during formation, and also as the reinforcement elements can be made of various alignments, thickness, height, materials according to the specification of the key cap structure or actual requirements, the key cap structure can be sufficiently strengthened.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A key cap structure, comprising:
a key cap configured with a bottom;
a connection structure; and
a reinforcement element, coupled to the bottom of the key cap by the connection structure.

2. The key cap structure of claim 1, wherein the reinforcement element is a flat plate.

3. The key cap structure of claim 1, wherein the reinforcement element further comprises at least a rib formed thereon.

4. The key cap structure of claim 3, wherein the at least one rib is formed by a manner selected from the group consisting of: integrally forming the at least one rib on the reinforcement element, and separately forming the at least one rib on the reinforcement element.

5. The key cap structure of claim 3, wherein the reinforcement element is comprised of a plurality of ribs, and the ribs, each being a flexible bar, are disposed in a manner selected from the group consisting of: the ribs are aligned parallel to each other, the ribs are aligned perpendicular to each other, the rib are aligned intercrossing with each other, and the combination thereof.

6. The key cap structure of claim 1, wherein the connection structure is composed of mating holes and protrusions.

7. The key cap structure of claim 6, wherein the holes are formed on the reinforcement element while the protrusions are formed on the bottom of the key cap at positions corresponding to the holes.

8. The key cap structure of claim 6, wherein the protrusions are mated tightly with the holes.

9. The key cap structure of claim 6, wherein the protrusions wedged inside the holes are fixed therein by a means selected from the group consisting of: thermal bonding and gluing.

10. The key cap structure of claim 1, wherein the connection structure is composed of a clasp and a groove.

11. The key cap structure of claim 10, wherein the clasp is formed on the bottom of the key cap while the groove is formed on the reinforcement element while at a position corresponding to the clasp.

12. The key cap structure of claim 1, wherein the connection structure is a clamping device capable of fixedly holding the reinforcement element by exerting a clamping force thereon.

13. The key cap structure of claim 1, wherein the reinforcement element and the connection structure are made of a material selected from the group consisting of metals, platics, composite materials and the combination thereof.

14. The key cap structure of claim 1, wherein the connection structure is formed by a manner selected from the group consisting of: integrally forming connection structure with the key cap, and separately f forming connection structure with the key cap.
